(19) United States
(12) Patent Application Publication
(10) Pub. No.: US 2003/0175320 A1
(43) Pub. Date: Sep. 18, 2003

(54) Device for containing animal repellant and attractant compositions

(76) Inventor: Mark J. Weiser, Evans City, PA (US)

Correspondence Address: BARRY I. FRIEDMAN, METZ LEWIS, LLC, 11 STANWIX STREET, 18TH FLOOR, PITTSBURGH, PA, 15222, US

(21) Appl. No.: 09/842,963

(22) Filed: Apr. 27, 2001

(51) Int. Cl. A01N 25/34; A01N 25/00; A01N 25/26; A01N 25/28

(52) U.S. Cl. 424/411; 424/412; 424/403; 424/405; 424/408; 424/414; 424/421; 424/84

(57) ABSTRACT

A device for emitting repellant odor or attractant scent comprising a closed container having odoriferous composition therein and being formed from thin sheet material which is pervious therethrough to gaseous effluent from the composition and is impervious to passage therethrough of liquid.

### BACKGROUND OF THE INVENTION

This invention relates generally to the field of influencing animal behavior and pertains particularly to the use of a device for emitting a selected odor from a saturated odoriferous composition held in a portable container.

My co-pending U.S. patent application Ser. No. ______, filed ______, discloses certain animal attractant and/or repellant compositions comprising a carrier material in formulation with such odoriferous constituents as selected animal urine or feces or glandular secretions which are employed to attract or repulse animals which are sensitive to the odor.

The present invention, which is intended to utilize such odoriferous compositions, is a device for emitting odor in the form of gaseous effluent in a particular area consistent with the location of the device.

There are various prior art U.S. patents which disclose subject matter pertaining to aromatic devices particularly intended to affect animals by attraction or repulsion. U.S. Pat. No. 4,302,899 issued to DeHart discloses the use of an aromatic sponge with a spring clip for holding it in a desired location and attract an animal by the scent impregnated in the sponge. U.S. Pat. No. 5,074,439 issued to Wilcox teaches the use of highly absorbent particles which will exude scent through the bag fabric. U.S. Pat. No. 5,611,165 issued to Blaha discloses the use of absorbent material within a pod having a closed position and top and bottom portions which can be manipulated apart to allow odor to escape from the absorbent material. U.S. Pat. No. 5,622,314 issued to Eason discloses a scent diffusion device including a container with a scent-absorbent wick which may be projected from the container to emit the scent. U.S. Pat. No. 5,672,342 issued to Bell discloses a method of collecting animal urine for use as an attractant. U.S. Pat. No. 5,916,552 issued to Perry teaches a method of making and using deer urine as an attractant in a semi-solid gelatin form.

Although the various prior art disclosures reveal usable devices and methods for luring animals by the use of selected natural odors, there remains the need for a device for containing an odoriferous composition that is permanently held in a container such that the user need never touch the composition but the odor from the composition can be dispensed as a gaseous effluent that passes through a liquid-tight container sidewall formed from a non-absorbent material.

### SUMMARY OF THE INVENTION

This invention comprehends the provision of a device for emitting repellant odor or attractant scent for luring or repulsing animals, such as deer or rodents. The device preferably comprises a closed container having an odoriferous composition therein and being formed from thin sheet material, which is pervious to the passage therethrough of gaseous effluent from the composition and is impervious to the passage therethrough of liquid forming part of the composition. The thin sheet material forming the container may be a fabric, sheet plastic, or sheet latex having microscopic pores to allow gaseous effluent to bleed therethrough.

In its preferred form, the composition within the container is pretreated by mixing an absorbent carrier material with urine or other animal secretions. The carrier material may be powder, granular, fibrous, solid, liquid, or gel. The container is preferably located within a fully sealed envelope that fits tightly about the container. This tight fit arrangement limits the space between the inside surface of the envelope and the outside surface of the container whereby the odoriferous effluent will be retained in the composition until the outer envelope is removed.

In one form of the invention, the container may be generally rectilinear in shape, having opposed outwardly-facing sidewalls, with one of the sidewalls being a base portion (not shown) that is impervious to the passage therethrough of the gaseous effluent from the composition whereby only one side of the container will exude the odor from the composition.

It is contemplated that the device of this invention may be provided in the form of a blister pack having a plurality of identical containers uniformly located on one side of a planar card, with the card having linear perforation lines defining the separate blisters so that individual containers can be torn from the card and placed at various selected locations consistent with luring or repelling animals in a given area.

The ensuing description of the preferred embodiment of the invention set forth herein should not be construed as limiting the scope of the invention. For example, variations in the materials of the components of the device constituting the invention, and the dimensions of its several parts, may be different from those shown and described herein without departing from the scope and spirit of the invention as determined and set forth by the appended claims.

### BRIEF DESCRIPTION OF THE DRAWINGS

FIG. 1 is an isometric view of a container which is a component of the present invention, the container having a portion thereof cut-away to reveal its interior;

FIG. 2 is an isometric view of a specific alternative embodiment of the present invention;

FIG. 3 is an elevational view illustrating the disposition of one embodiment of the present invention; and

FIG. 4 is a side elevational view of the device first illustrated in FIG. 1 but here shown in a particular disposition consistent with its use.

### DETAILED DESCRIPTION OF THE PREFERRED EMBODIMENTS

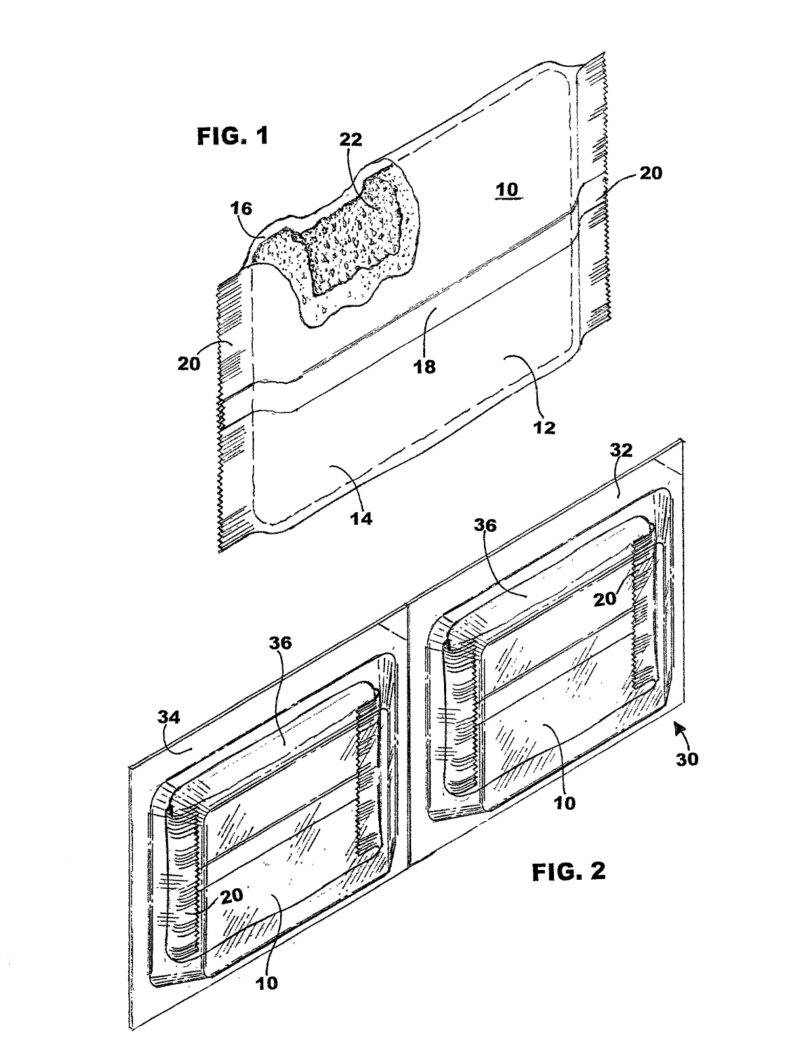

FIG. 1 illustrates a container 10 formed from a flexible sheet material 12. The container 10 has opposite front and back sides 14 and 16, a longitudinal seal fold 18, and closed ends 20. Encapsulated within the container 10 is an odoriferous composition 22 constituting powder, granular, solid, liquid, or gel material that has been permeated with a specific odor, preferably urine liquid or other animal secretions.

FIG. 2 illustrates a blister pack 30 constituting a planar card 32 having a face side 34 with outwardly-projecting blister portions 36 thereon. Each blister 36 is preferably formed from a semi-rigid plastic material and encloses a container 10 therein. In FIG. 2, the ends 20 of the container 10 shown in FIG. 1 are folded inwardly but may be pulled outwardly for handling the container when it is removed from the blister. The card 34 has a linear perforation line 38 to enable severance on one blister pack from the other, and it should be understood that a blister pack in accordance with the illustration in FIG. 2 might contain a large multiplicity of the blister packs on the substantially larger display card 34, with intervening perforated lines on the card to enable separation as heretofore described.

A critical feature of the present invention is that the sheet material from which the container 12 is constructed is quite thin and has microscopic pores throughout to permit gaseous effluent to pass through the container sidewall from the composition 22 as shown in FIG. 1. A further important feature relates to the material forming the blister 36 and the card stock 34, both of which are impervious to the passage therethrough of gaseous effluent, and the blister 36 is intentionally fitted in close or contiguous proximity to the sidewall of the container 12 whereby effluent emission does not occur from the container 12 until such time as the enclosing package, such as the blister 36, is torn or otherwise removed.

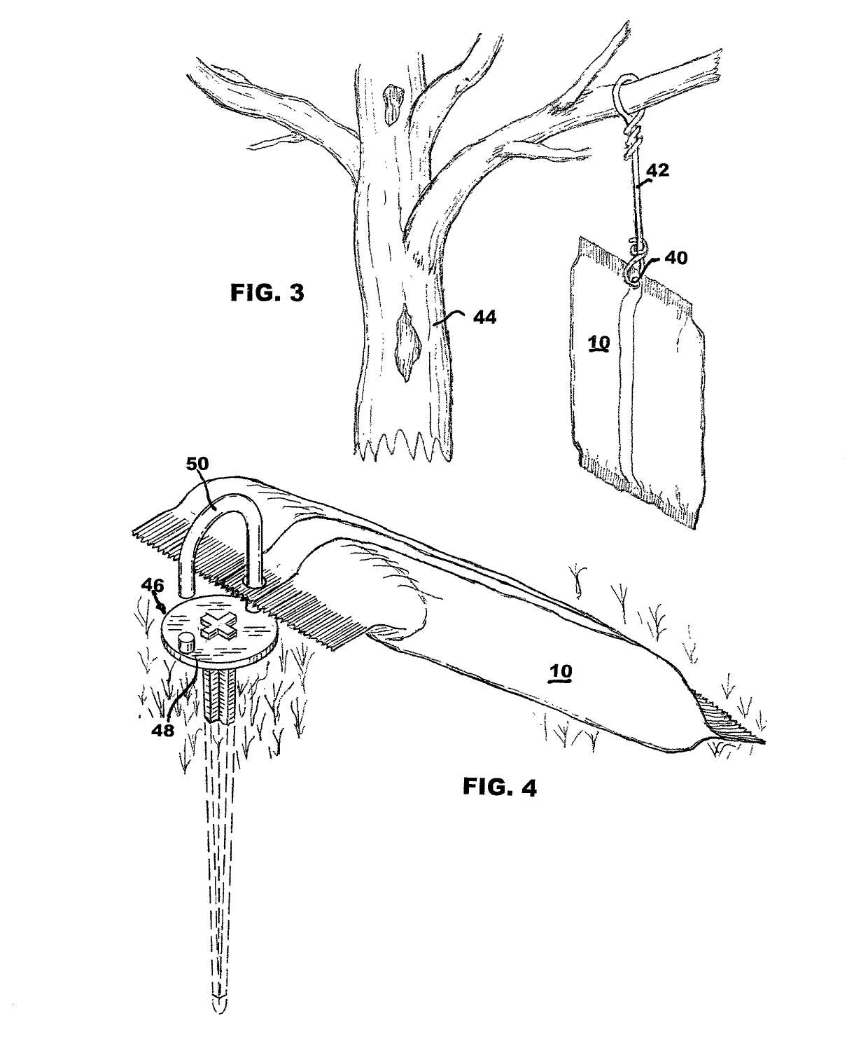

FIG. 3 illustrates a presently preferred method of locating the device 10 to serve as an animal attractant or repellant, depending upon the composition contained within the device 10. A flap aperture 40 is provided at one end of the device 10 to enable connection therethrough of a wire twist tie 42 which may be used to attach the device 10 in a suspended disposition on a branch of a tree 44.

FIG. 4 illustrates an alternative method of positioning the device 10 by utilization of a rigid plastic stake structure 46 which may be pushed into the earth whereby an integral upwardly-projecting hook 50 is used to attach to the device 10 through the flap aperture 40.

1. A device for emitting repellant odor or attractant scent comprising:
a closed container having odoriferous composition therein and being formed from thin sheet material which is pervious to the passage therethrough of gaseous effluent from the composition and is impervious to passage therethrough of liquid.

2. The device of claim 1 wherein the thin sheet material is a fabric.

3. The device of claim 1 wherein the thin sheet material is a woven fabric.

4. The device of claim 1 wherein the thin sheet material is plastic having a thickness within the range of one to five millimeters.

5. The device of claim 1 wherein the thin sheet material is latex.

6. The device of claim 1 wherein the thin sheet material is perforated plastic.

7. The device of claim 1 wherein the container is formed as a pouch having opposite flat sidewalls sealably joined at contiguous peripheral edges.

8. The device of claim 1 wherein the sheet material is flexible and semi-rigid.

9. The device of claim 1 containing pre-scented granular composition.

10. The device of claim 1 containing pre-scented powder composition.

11. The device of claim 1 containing pre-scented fibrous composition.

12. The device of claim 1 wherein the composition within the container is a pre-scented solid.

13. The device of claim 5 having a rectilinear shape.

14. The device of claim 5 having a circular shape.

15. The device of claim 5 being contained within a sealed envelope.

16. The device of claim 5 wherein the sealed envelope is formed from sheet plastic impervious to passage therethrough of gaseous effluent.

17. A method of attracting or repelling animals by use of a selected odoriferous composition, comprising the steps of:
preparing the odoriferous composition;
placing the odoriferous composition in a container being sealed against liquid leakage and allowing outward penetration and escape therefrom of odor from the composition; and
locating the container so that nothing physical prevents approach by an animal to the container.

18. The device of claim 10 wherein the device is fitted within the sealed envelope in a tightly fitted disposition thereby limiting space between the outer surface of the device and the inner surface of the envelope.

19. The device of claim 5 being formed with a sidewall section that is impervious to the passage of gaseous affluent therethrough.

20. A plurality of identical devices, each comprising a closed container having odoriferous composition therein and being formed from thin material which allows the passage therethrough of gaseous effluent from the composition and is impervious to passage of liquid therethrough, except for a sidewall section that is impervious to passage of gaseous effluent or liquid therethrough.

21. A plurality of identical devices as in claim 14, the devices being mounted on a flat, substantially stiff sheet having opposite side surfaces, with the devices aligned uniformly on the same flat surface of the sheet.

22. The invention of claim 14 wherein the sheet is scored on one surface in a pattern forming sections of equal area, and one device from the plurality is affixed to each section.

23. A blister pack dispensing device for animal attractant and repellant comprising:
a planar card;
one surface of the card having a plurality of identical blisters disposed in a uniform arrangement thereon;
each blister formed from a non-porous material and defining a pocket enclosing a container having a porous sidewall;
an absorbent material contained in the pocket and being saturated with a selected attractant or repellant liquid; and
the porous plastic being impervious to passage therethrough of liquid and having fine pores permitting gaseous emission outward from the pocket.
